(19) United States
(12) Patent Application Publication
(10) Pub. No.: US 2021/0071818 A1
(43) Pub. Date: Mar. 11, 2021

(54) PROCESS AND APPARATUS FOR DISPENSING GAS FROM A STORAGE VESSEL

(71) Applicant: Numat Technologies Inc., Skokie, IL (US)

(72) Inventor: Jose Arno, Chicago, IL (US)

(21) Appl. No.: 17/010,657

(22) Filed: Sep. 2, 2020

Related U.S. Application Data
(60) Provisional application No. 62/896,475, filed on Sep. 5, 2019.

(51) Int. Cl. F17C 13/04

(52) U.S. Cl. CPC F17C 13/04; F17C 2205/0391; F17C 2205/0338; F17C 2205/0335; F17C 2205/0329

(57) ABSTRACT

Disclosed is a valve assembly and process for dispensing gas from a storage vessel that comprises a nozzle for discharging the gas. The valve assembly has a passage having a first end is in communication with the nozzle, and a second end in communication with an interior of the storage vessel where the gas is stored. A shut off valve is interposed in the passage for blocking or allowing gas to pass between said first end and the second end of the passage. A check valve may be secured in a bore of the nozzle to prevent accidental gas discharge.

### CROSS-REFERENCE TO RELATED APPLICATIONS

This application claims priority from provisional application 62/896,475, filed Sep. 5, 2020, incorporated herein in its entirety.

### FIELD

The field relates to a valve assembly for a gas storage vessel useful in manufacturing applications.

### BACKGROUND

In a wide variety of industrial processes and applications, there is a need for a reliable source of process gas(es). Such process and application areas include semiconductor manufacturing, ion implantation, manufacture of flat panel displays, medical intervention and therapy, water treatment, emergency breathing equipment, welding operations, space-based delivery of liquids and gases, etc.

It is important in the industry to provide a safe and effective way to handle toxic, flammable, corrosive gases at sub-atmospheric conditions. In particular, these gases include dopant gases. Generally, dopant gases are stored in compressed gas cylinders at pressures equal to the gas vapor pressure at a given or at a specific pressure depending upon the properties of the specific gas. The gases serve as a source of dopant material for the manufacturing of semiconductor devices. These dopant gases are used in a tool called an ion implanter. Ion implanters are located within the fabrication area of a semiconductor production facility where several hundreds or even thousands of personnel are engaged in the semiconductor manufacturing process. These tools are operated at very high voltages, typically up to several thousand kilovolts. Due to these high voltages, the dopant source gases must be located at or within the tool itself. Most other semiconductor tools locate source gases outside of the personnel or main production area. One distinct characteristic of the ion implant tools is that they operate at sub-atmospheric pressure. Utilization of the vacuum present at the tool to deliver product from the cylinder creates a safer package in that product cannot be removed from the cylinder package until a vacuum is applied. This vacuum delivery concept prevents accidental exposure to the pressurized gas.

One technique for safely delivering sub-atmospheric delivery of dopant gases involves filling a compressed gas cylinder with a physical adsorbent material, such as beaded activated carbon, and reversibly adsorbing the dopant gases onto the material. This concept is commonly known as the SDS technology. The desorption process involves applying a vacuum or heat to the adsorbent material/cylinder.

A mechanical pressure regulator may be used for safe sub-atmospheric delivery of dopant gases. The pressure regulator is set to open when sub-atmospheric or vacuum conditions are applied to the device. Typically, application of the sub-atmospheric condition causes a flexible material to flex when reaching a pre-set pressure actuating the regulator valve in order to enable gas flow. The valve is located upstream of a conventional on/off cylinder valve seat mechanism. The exact location of this upstream device can be in the valve body, in the cylinder neck cavity, inside the cylinder itself, or combinations of all three locations.

It would be desirable to provide even safer devices for dispensing gas from a storage device.

### SUMMARY

Disclosed is a valve assembly for dispensing gas from a storage vessel that comprises a nozzle for discharging the gas. The nozzle defines a bore. The valve assembly has a passage having two ends. A first end is in communication with the nozzle, and a second end is in communication with an interior of the storage vessel where the gas is stored. A shut off valve is interposed in the passage for blocking or allowing gas to pass between said first end and the second end of the passage. A check valve may be secured in the bore. A process for dispensing gas from the storage vessel comprises biasing an obstruction in a chamber into engagement with a channel in a nozzle to prevent passage of fluid from the channel to the chamber. An interior volume of the storage vessel is communicated with the nozzle. Pressure in the chamber is reduced to below the pressure in the channel sufficiently to move the obstruction out of engagement with the channel to permit passage of fluid from said channel to said chamber.

### BRIEF DESCRIPTION OF THE DRAWINGS

FIG. 1 is a schematic cross-sectional elevation view of a gas storage and dispensing system according to one embodiment of the present disclosure.

FIG. 2 is an isometric view of an alternative valve assembly of FIG. 1.

FIG. 3 is a sectional view of a check valve of the present disclosure.

FIG. 4 is a sectional view of an alternative check valve of FIG. 3.

FIG. 5 is a graphical presentation of data exhibited by the embodiment of the disclosure.

### DETAILED DESCRIPTION

A valve assembly and process are disclosed that utilizes a check valve in the nozzle of the storage vessel to prevent leakage of gases. Stored gases can be extremely toxic. For example, arsine has a toxicity limit of as low as 5 wppb. Concern has arisen for accidental leakage from storage vessels if the shut off valve is accidentally left open. In storage vessels in which adsorbent is used to store the gas, leakage of air into the interior of the storage vessel can cause temperature and pressure fluctuations that induce stored gas to desorb from the adsorbent and leak from the nozzle of the valve assembly. Leakage of stored gas can also occur upon failure of the mechanical valve that is contained in the interior of the storage vessel or in the valve assembly.

Proposed is the use of a check valve in the nozzle of the valve assembly to prevent air from passing into the nozzle and into the interior of the storage vessel to cause temperature fluctuations and to block emission of the stored gas from the storage vessel through the nozzle. The check valve would safely prevent accidental discharge from storage vessels that store gas on adsorbent. The check valve could also be used on storage vessels that use a mechanical valve to prevent discharge to guard against mechanical valve failure. The check valve proposed would maintain emission levels well below the limit of 5 wppb.

Improper cycle purging or accidental opening of the cylinder to atmospheric air can allow contamination from foreign gases entering the storage vessel. In addition to the aforementioned safety advantages, the check valve would also prevent contamination from foreign gases entering the storage vessel.

The valve assembly provides a reliable source of gas having particular suitability for use in semiconductor manufacturing facilities to provide on-demand supply of gases, such as halocompound gases; e.g., BF₃, F₂, etc., hydride gases; e.g., arsine, phosphine, etc., and gaseous organometallic source reagents.

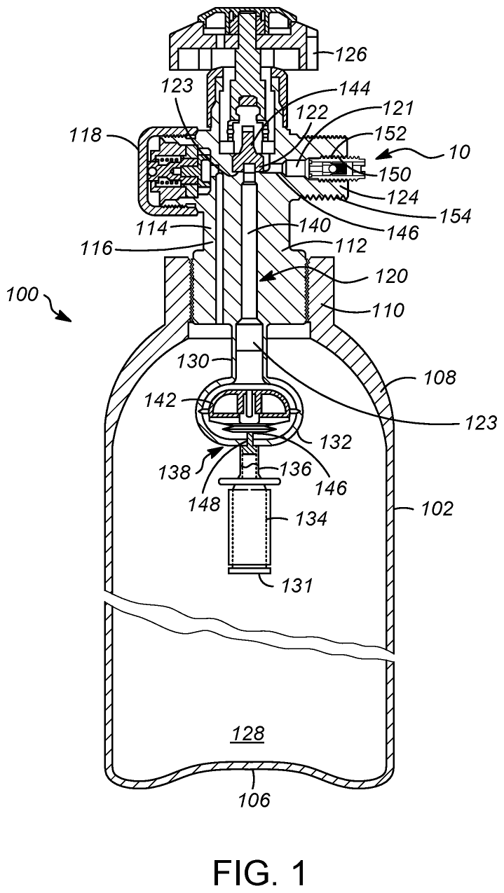

Referring now to the drawings, FIG. 1 is a schematic cross-sectional elevation view of one gas storage vessel 100 according to an illustrative embodiment. The storage vessel 100 may be a fluid storage and dispensing vessel of generally cylindrical form, with a cylindrical wall 102 closed at its lower end by floor member 106. At the upper end of the vessel is a neck 108 including a cylindrical collar 110 defining and circumscribing a top opening of the vessel 100. The wall 102, floor member 106 and neck 108 thereby enclose an interior volume 128 of the vessel 100, as shown.

At the neck of the vessel, a threaded plug 112 of a valve assembly 114 is threadably coupled with the interior threaded opening of the collar 110 of the storage vessel 100. The valve assembly 114 includes a passage 120 having a first end 121 in communication with a nozzle 124 and a second end 123 of the passage 120 is in communication with the interior volume 128 of the vessel 100. The nozzle 124 communicates the interior volume 128 of the vessel 100 with the environment outside of the vessel. Hence, the nozzle 124 is for dispensing gas from the vessel 100 and it is contemplated to be for charging gas to the vessel. The nozzle 124 may have external threads 154 for a male connection with a gas tube having an end fitting with corresponding internal threads.

The nozzle 124 defines a bore 150 therein. A check valve 10 is secured in the bore of the nozzle 124 to further prevent against the gas in the interior volume 128 leaking from the nozzle 124 unintentionally.

The passage 120 has several segments. A central segment 140 of the passage 120 passes between a shut off valve 122 and a regulator 132. The shut off valve 122 is interposed in the passage 120 for blocking or allowing gas to pass between the first end 121 and the second end 123 of the passage 120. The shut off valve 122 is sealed having an orifice in a seat 123 on a side of the valve toward the central segment 120. A flexible member 144 is displaced by gas when the flexible member is in a relaxed condition to allow gas to flow past the shut off valve 122 enabling communication between the central segment 140 and a nozzle segment 146 of the passage 120. When a hand wheel 126 is cranked clockwise, it compresses the flexible member 144 which enters a compressed condition that prevents passage of gas through the orifice past the shut off valve 122. The nozzle segment 146 is part of the passage 120 that communicates the central segment 140 through the shut off valve 122 with the nozzle 124.

The valve assembly 114 may feature a fill passage 116 communicating with a fill port 118 and the interior volume 128 of the vessel. The vessel 100 may thereby be charged with pressurized gas, following which the fill port is closed and capped, as shown.

The central fluid flow passage 120 in the valve head assembly 114 is joined at its second end 123 to a connector flow tube 130, to which in turn is joined to the regulator 132. The regulator 132 is set to maintain a selected pressure of the fluid discharged from the vessel. The regulator 130 is set at a particular pressure. The regulator 130 includes a mechanical valve 138. When the nozzle 124 is subjected to a lower pressure, the shut off valve 122 may be opened to equalize the lower pressure to the regulator 132. A bellows 142 made of a flexible material expands to displace a poppet 146 downwardly to allow gas from the interior volume 128 to pass into the regulator 132 through a port 148 around the poppet. The gas then travels into the passage 120 through the second end 123.

At the lower end of the regulator is joined a tubular fitting 136 which in turn is joined, e.g., by butt welding, to a filter unit 134 having a diffuser end cap 131 at its lower extremity. The filter unit may be formed of stainless steel, with the diffuser wall being formed of a sintered stainless steel such as 316L stainless steel. The filter unit has a wall porosity that permits removal of all particles greater than a predetermined diameter, e.g., greater than 0.003 micrometers at 30 standard liters per minute flow rate of gas from the system.

In use, a pressurized gas is contained in the interior volume 128 of the vessel 100. The gas pressure regulator 132 is set to a selected set point to provide flow of dispensed gas when the valve in the valve assembly 114 is opened, with the gas flowing through the filter unit 134, fitting 136, regulator 132, connector flow tube 130, passage 120 in the valve assembly 114, the shut off valve, and nozzle 124. The valve assembly 114 may be joined to other piping, conduits, flow controllers, monitoring means, etc. as may be desirable or required in a given end use application of the invention.

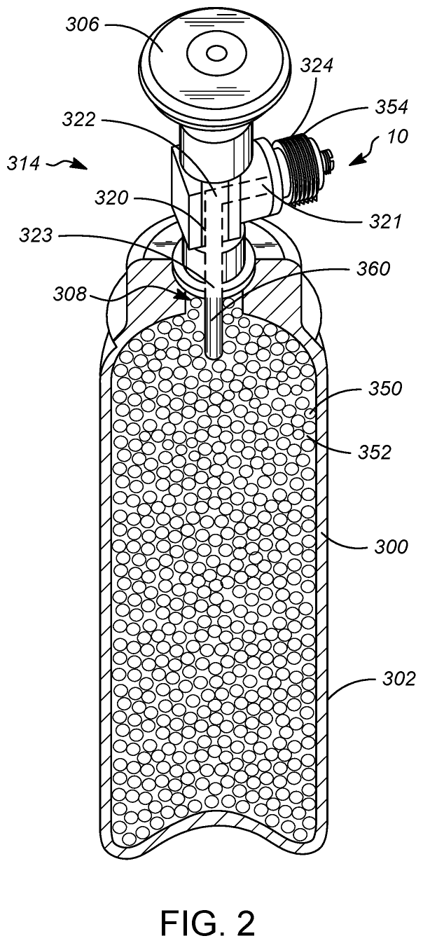

FIG. 2 is a perspective cross-sectional view of a storage vessel 300 which relies on adsorbent in the vessel to avoid unintended discharge. FIG. 2 shows the interior structure of the storage vessel 300. As shown, the storage vessel 300 comprises a wall 302 enclosing an interior volume 352 of the vessel and containing a particulate sorbent material 350 therein. At the upper end of the vessel, at a valve assembly 314, a port 308 may feature porous centered tube 360, or other foraminous or otherwise gas-permeable structure serving to prevent entrainment in the dispensed gas of particulate solids from the bed of the sorbent material. The storage vessel also includes a nozzle 324 for dispensing gas from and charging gas to the storage vessel 300. The nozzle 324 may also include a check valve 10 secured therein. The nozzle 324 may have external threads 354 for a male connection with a gas tube having an end fitting with corresponding internal threads.

The valve assembly 304 also includes a passage 320 shown in phantom having a first end 321 in communication with the nozzle 324 and a second end 323 in communication with an interior volume of the storage vessel 352. A shut off valve 322 operated by the wheel 306 is interposed in the passage 320 for blocking or allowing gas to pass between the first end 321 and the second end 323 of the passage. By connecting the nozzle 324 to a tube connected to a source of gas at subatmospheric pressure, opening the shut off valve 322 by turning the wheel and allowing the subatmospheric pressure to equalize to the adsorbent, gas is desorbed from the adsorbent and is dispensed from the nozzle 324.

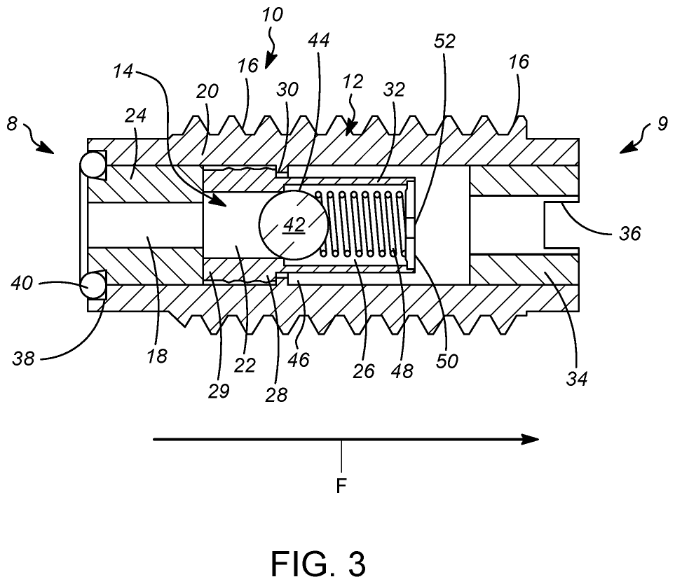

The check valve 10 in the nozzle 124 of FIG. 1 and 324 of FIG. 2 serves to prevent the accidental discharge gases from the respective storage vessel 100, 302. FIG. 3 illustrates a suitable check valve 10 in detail. The check valve 10 is secured in the nozzle 124, 324

The check valve 10 comprises a body 12 defining a channel 14 in communication with the passage 120, 320 when secured in the nozzle 124, 324. The check valve 10 may be secured in the nozzle 124 in a bore 150 such as shown in FIG. 1. The check valve 10 may be cylindrical and hollow, and the bore 150 may have a corresponding configuration. The bore 150 may be internally threaded as shown in FIG. 1 with internal threads 152 for female connection with external threads 16 on the body 12 of the check valve 10 as shown in FIG. 3. The check valve 10 may alternatively be swaged or friction fitted into a bore 150 in the nozzle 124, 324. The check valve 10 has an upstream end 8 that is proximate to the valve assembly 114, 314 and a downstream end 9 that is distal from the valve assembly 114, 314 in reference to the direction of flow F from the valve assembly during fluid discharge.

In an embodiment, the body 12 may comprise an outer shell 20 defining an internal duct 22 with one or more inserts therein to provide the desired internal configuration of the duct. The channel 14 may be preceded by a flow restriction channel 18. The flow restriction channel 18 may have a narrowed inner diameter. The flow restriction channel 18 may be provided by a tubular insert 24 in the passageway 22 in the upstream end 8 of the check valve 10. The channel 14 may be adjacent to the flow restriction channel 18 and have a larger internal diameter than the flow restriction channel 18. It may also be viewed that the channel 14 has two inner diameters, the smallest inner diameter defined by the tubular insert 24. The body 12 defines a chamber 26 adjacent to the channel 14 which is in communication with the channel. In an embodiment, the chamber 26 and the channel 18 may be provided by a counterbore insert 28 friction fitted into the duct 22. The channel 18 may be provided by a larger outer diameter section 29 of the counterbore insert 28 that is sandwiched in place between the tubular insert 24 and an annular flange 30. The chamber 26 may be provided by a smaller outer diameter section 32 of the counterbore insert 28 and extend past and through the annular flange 30 toward the downstream end 9 of the check valve 10. A tail insert 34 may be fixed into the downstream end 9 of the duct 22 of the body 12. The tail insert 34 may also be tubular and restrict flow through a narrowed inner diameter. The tail insert 34 may have a tool receiving recess 36 to mate with a machine head such as a screwdriver to facilitate securing the check valve 10 into the nozzle 124, 324. An annular recess 38 at the upstream end 8 of the check valve 10 may receive an o-ring 40 to facilitate fluid tight engagement with a mating surface in an interior of the nozzle 124, 324.

The chamber 26 may have a larger lateral dimension than the channel 14. In an embodiment, the chamber 26 may have a larger inner diameter than the inner diameter of the channel 14. An obstruction 42 is contained in the chamber 26. The chamber 26 includes a movable obstruction 42 that can move into engagement with the channel 14 to prevent fluid flow through the check valve 10 and out of engagement with the channel to allow fluid flow through the check valve. The obstruction 42 has a lateral dimension that is larger than the lateral dimension of the channel 14, so that the obstruction can obstruct fluid from entering the channel 14 when the obstruction is engaged with the channel 26. However, the obstruction 42 and the channel 14 are dimensioned to prevent the obstruction from completely entering the channel 14. In an embodiment, the obstruction is engaged with a downstream end 44 of the channel thereby defining an aperture 46 by the interface of the channel 14 with the chamber 26. In an embodiment, the obstruction has an outer diameter that is larger than the inner diameter of the channel 14.

In an illustrated embodiment, the obstruction 42 is a sphere which may be metal. The channel 14 may be cylindrical. The spherical obstruction 42 can engage with the downstream end 44 of the cylindrical channel 14 to prevent gas flow while the obstruction is engaged with the channel. The obstruction may also be a diaphragm that is secured in engagement with the channel 14, specifically the aperture 44, to prevent flow upstream against the flow direction F.

When installed in the nozzle 124, 324, the channel 14 is closer to the passage 120, 320 than the chamber 26, so the channel is also closer to the upstream end 8 of the check valve 10 than the chamber 26.

In operation, the obstruction 42 is engaged with the channel 14 to prevent gas from leaking into the storage vessel 100, 300 against the flow direction F, which could cause gas to desorb from adsorbent in the storage vessel 300 and leak out into the atmosphere particularly if the shut off valve 122, 322 is accidentally left open in the embodiment of FIG. 2. In addition, should the mechanical valve 138 fail in the embodiment of FIG. 1, the subatmospheric pressure present in the interior volume 128 would not overcome the biasing force acting against the obstruction counter to the flow direction, F to allow leakage.

In an embodiment, a spring 48 secured with a downstream end against a wall 50 in the chamber 26 and an upstream end engaged with the obstruction 42 biases the obstruction 42 into engagement with the end 46 of the channel 14. The wall 50 has a tunnel 52, for example, therethrough to allow gas to pass the downstream end 9 of the check valve 10.

The spring should exert just enough biasing force on the obstruction to hold the valve closed. Otherwise, one would not be able to dispense all the gas from the storage vessel 100, 300 without removing the check valve 10 from the nozzle 124, 324. A pressure differential equaling the pressure at the upstream end 8 less the pressure at the downstream end 9 should be between 0.01 Torr (0.0002 psi) and 517 Torr (10 psi) to ensure adequate discharge of stored gas.

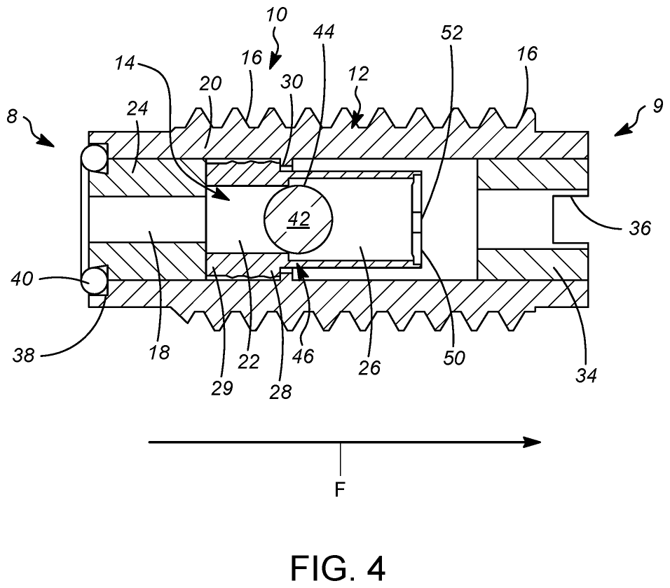

FIG. 4 shows an alternative embodiment which differs from the embodiment in FIG. 3 in that it uses no spring to bias the obstruction 42 into engagement with the channel 14. Instead, a small pressure differential operates to provide the bias. Pressure in the interior volume 128, 352 of the storage vessel 100, 300, respectively, in FIGS. 1 and 2 is subatmospheric such as between 1 and 700 Torr at the upstream end 8 of the check valve. Atmospheric pressure at the downstream end 9 of the check valve 10 would be around 760 Torr, thus pressing the obstruction into engagement with the end 46 of the channel 14 and preventing leakage of gas from the vessel. The channel 14 would be at a lower pressure than the chamber 26 to bias the obstruction into engagement with the channel. When a line is connected to the nozzle 124, 324 that will impose a smaller subatmospheric pressure on the valve assembly 114, 314 than in the vessel 100, 300, the obstruction 42 will displace from the channel 14 toward the downstream end 9 to allow gas from the interior volume 128, 352 to flow from the vessel 100, 300 through the check valve 10 and the nozzle 124, 324. A very small differential pressure will allow gas flow through the check valve 10. In an aspect, a magnet may also be used to move a metallic obstruction 42 toward the downstream end 9 to allow the flow of gas through the check valve 10 in either direction.

In typical storage, an obstruction 42 in the chamber 26 of the check valve 10 is biased into engagement with a channel 14 in the nozzle 124, 324 to prevent unintended passage of fluid from the channel to the chamber. Biasing may bear on the obstruction by use of a spring 48 or by differential pressure. To dispense gas from the storage vessel 100, 300 an interior volume 128, 354 of the storage vessel 100, 300 is communicated with the nozzle 124, 324. This can be initiated by opening the shut off valve 122, 322 to allow equalization of pressure down the passage 120. Communication of pressure may be communicated to the flexible member 144 of the mechanical valve 138 that flexes to open the port 148 to enable fluid in the storage vessel 100 to pass through the passage 120. Communication of pressure in another embodiment may be communicated to the adsorbent 350 with gas sorbed thereon in the interior volume 352 to desorb gas therefrom to enable fluid in storage vessel 300 to pass through the passage 320. Additionally, pressure in the chamber 26 must be reduced to below the pressure in the channel 14 sufficiently to move the obstruction 42 out of engagement with the channel 14 to permit passage of fluid from the channel 14 to the chamber 26. By hooking up a tube to the nozzle 124, 324 perhaps by using the external threads 154, 354 thereon and imposing pressure that is less than the pressure in the interior volume 128, 328 of the storage vessel 100, 300, pressure in the chamber 26 can be reduced sufficiently to allow gas to flow through the check valve 10. Gas will pass from the storage vessel 100, 300 through the passage 120, 320 past the obstruction 42 and though the nozzle 124, 324.

To fill the storage device, the check valve 10 may be removed from the nozzle 124, 324 and securing a gas tube to the nozzle to fill the storage vessel with fluid through the nozzle against the typical direction of flow, F in FIGS. 3 and 4.

The present disclosure provides an apparatus and process that makes storage of gases in storage vessels much safer and freer from contamination.

### Example

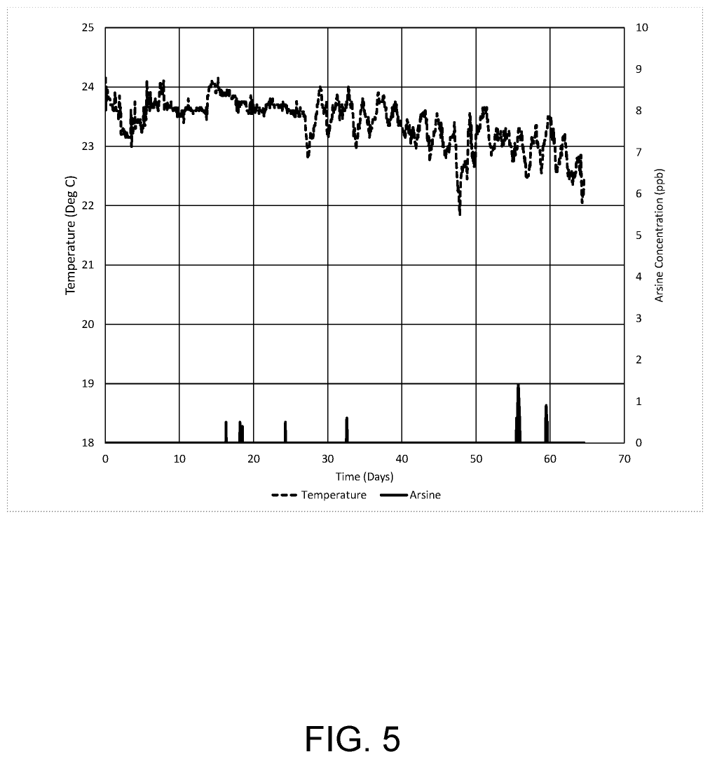

To test the check valve 10, a check valve was inserted in the nozzle 324 of a valve assembly 314 of a storage vessel 300 similar to that of FIG. 2 containing arsine gas. The interior volume 328 was at 650 Torr. The shut off valve 322 was fully opened and the release concentration was measured for two months. Results are shown in FIG. 5. The temperature fluctuated around 23° C.±1 C°. The release rate was mostly zero with sporadic minute ventings. At a ventilation rate of 1.4 standard m³/min. (50 standard ft³/min.) released levels were well below 5 ppb of arsine gas. The average release was 0 ppb with a max peak of 1.5 ppb.

Without the check valve 10 under the same conditions, releases were well above 5 ppb of arsine gas with an average of 21.6 ppb and a max peak of 81.3 ppb when the shut off valve was left open.

While the following is described in conjunction with specific embodiments, it will be understood that this description is intended to illustrate and not limit the scope of the preceding description and the appended claims.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A valve assembly for dispensing gas from a storage vessel, comprising:
a nozzle for dispensing gas from the storage vessel;
a passage having a first end in communication with said nozzle and a second end in communication with an interior volume of the storage vessel;
a shut off valve interposed in said passage for blocking or allowing gas to pass between said first end and said second end of said passage; and
a check valve secured in said nozzle.

2. The valve assembly of claim 1 wherein said check valve comprises an body defining a channel in communication with said passage and a chamber in communication with said channel, said chamber including a movable obstruction that can move into engagement with said channel to prevent fluid flow through said check valve and out of engagement with said channel to allow fluid flow through said check valve.

3. The valve assembly of claim 2 wherein said chamber has a larger lateral dimension than said channel.

4. The valve assembly of claim 2 wherein said obstruction is contained in said chamber.

5. The valve assembly of claim 2 wherein said channel is closer to said passage than said chamber.

6. The valve assembly of claim 2 wherein said channel is at a lower pressure than said chamber to bias said obstruction into engagement with said channel.

7. The valve assembly of claim 2 wherein further comprising a spring in said chamber biasing said obstruction into engagement with said channel.

8. The valve assembly of claim 1 wherein said nozzle has external threading for a male connection with a gas tube and said bore has an internal threading for female connection with an external threading of said check valve.

9. The valve assembly of claim 1 further comprising a regulator interposed in said passage for regulating the flow of gas through said passage.

10. The valve assembly of claim 1 further comprising an adsorbent in said storage vessel in communication with said passage.

11. A process for dispensing gas from a storage vessel, comprising:
biasing an obstruction in a chamber into engagement with a channel in a nozzle to prevent passage of fluid from said channel to said chamber;
communicating an interior volume of said storage vessel with said nozzle,
reducing pressure in the chamber to below the pressure in the channel sufficiently to move the obstruction out of engagement with the channel to permit passage of fluid from said channel to said chamber.

12. The process of claim 11 further comprising passing gas from the storage vessel through said passage past said obstruction and though said nozzle.

13. The process of claim 11 wherein said biasing is provided by a spring.

14. The process of claim 11 wherein said biasing is provided by differential pressure.

15. The process of claim 11 wherein reducing pressure in said chamber communicates a reduction in pressure to a flexible member that flexes to open a port to enable fluid in said storage vessel to pass through said passage.

16. The process of claim 11 wherein reducing pressure in said chamber communicates a reduction in pressure to adsorbent in said storage vessel which desorbs fluid sorbed on said adsorbent to enable fluid in said storage vessel to pass through said passage.

17. The process of claim 11 wherein said obstruction is contained in a check valve and further comprising removing said check valve from said nozzle and securing a gas tube to said nozzle to fill said storage vessel with fluid.

18. A valve assembly for dispensing gas from a storage vessel, comprising:
a nozzle for dispensing gas from the storage vessel, said nozzle defining a bore;
a passage having a first end in communication with said nozzle and a second end in communication with an interior volume of the storage vessel;
a shut off valve interposed in said passage for blocking or allowing gas to pass between said first end and said second end of said passage; and
a check valve secured in said bore, said check valve comprising an outer body defining a channel in communication with said passage and a chamber in communication with said channel, said chamber including a movable obstruction that can move into engagement with said channel to prevent fluid flow through said check valve and out of engagement with said channel to allow fluid flow through said check valve.

19. The valve assembly of claim 18 wherein said channel is at a lower pressure than said chamber to bias said obstruction into engagement with said channel.

20. The valve assembly of claim 18 wherein said nozzle has external threading for a male connection with a gas tube and said bore has an internal threading for female connection with an external threading of said check valve.
